(19) United States
(12) Patent Application Publication
(10) Pub. No.: US 2025/0377562 A1
(43) Pub. Date: Dec. 11, 2025

(54) ELECTRONIC DEVICE

(71) Applicant: INNOLUX CORPORATION, Miao-Li County (TW)

(72) Inventors: Hsu-Kuan HSU, Miao-Li County (TW); Tzu-Chieh LAI, Miao-Li County (TW); Chih-Chin KUO, Miao-Li County (TW); En-Hsiang CHEN, Miao-Li County (TW); Wenqi LIN, Miao-Li County (TW); Mao-Shiang LIN, Miao-Li County (TW)

(21) Appl. No.: 19/202,367

(22) Filed: May 8, 2025

(30) Foreign Application Priority Data
Jun. 5, 2024 (CN) 202410722360.6

(51) Int. Cl. G02F 1/1335; G02F 1/133; G02F 1/1347

(52) U.S. Cl. CPC G02F 1/133514; G02F 1/13324; G02F 1/133512; G02F 1/1347

(57) ABSTRACT

An electronic device has multiple pixel areas, which are divided into multiple first regions and multiple second regions. The electronic device includes a first panel, a second panel, multiple first filter units, and multiple second filter units. The first panel includes a first cholesteric liquid crystal layer for reflecting a first color light. The second panel is disposed at one side of the first panel and includes a second cholesteric liquid crystal layer for reflecting a second color light. The first filter units and the second filter units are disposed between the first cholesteric liquid crystal layer and the second cholesteric liquid crystal layer. The first filter units are respectively located in the first regions, and the second filter units are respectively located in the second regions. The first filter units and the second filter units are configured to absorb lights of different colors.

### CROSS REFERENCE TO RELATED APPLICATIONS

This Non-provisional application claims priority under 35 U.S.C. § 119 (a) on Patent Application No(s). 202410722360.6 filed in People's Republic of China on Jun. 5, 2024, the entire contents of which are hereby incorporated by reference.

### BACKGROUND

### Technology Field

The present disclosure relates to an electronic device and, in particular, to a reflective display device.

### Description of Related Art

The reflective display device includes, for example, multiple panels, which include cholesteric liquid crystals used to reflect lights of different colors. The reflective display devices have the advantage of energy saving or low power consumption. However, there are still some improvements of the reflective display devices, such as the design of double-sided display function.

### SUMMARY

This disclosure is to provide an electronic device that can achieve the double-sided display function.

An electronic device of this disclosure has a plurality of pixel areas, which are divided into a plurality of first regions and a plurality of second regions, and includes a first panel, a second panel, a plurality of first filter units, and a plurality of second filter units. The first panel includes a first cholesteric liquid crystal layer for reflecting a first color light. The second panel is disposed at one side of the first panel and includes a second cholesteric liquid crystal layer for reflecting a second color light. The first filter units and the second filter units are disposed between the first cholesteric liquid crystal layer and the second cholesteric liquid crystal layer. The first filter units are respectively located in the first regions, and the second filter units are respectively located in the second regions. The first filter units and the second filter units are configured to absorb lights of different colors.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1A is a partial sectional view of an electronic device according to a first embodiment of this disclosure;

FIG. 1B and FIG. 1C are schematic diagrams showing different arrangements of the first regions and the second regions in a plurality of pixel areas of the electronic device as shown in FIG. 1A;

FIG. 1D is a schematic diagram showing the traveling path of the ambient light in the first region of the electronic device as shown in FIG. 1A;

FIG. 1E is a schematic diagram showing the traveling path of the ambient light in the second region of the electronic device as shown in FIG. 1A;

FIG. 2A and FIG. 2B are partial sectional views of different aspects of electronic devices according to a second embodiment of this disclosure;

FIG. 3A is a partial sectional view of an electronic device according to a third embodiment of this disclosure;

FIG. 3B is a schematic diagram showing the traveling path of the ambient light in the first region of the electronic device as shown in FIG. 3A;

FIG. 3C is a schematic diagram showing the traveling path of the ambient light in the second region of the electronic device as shown in FIG. 3A;

FIG. 4A is a partial sectional view of an electronic device according to a fourth embodiment of this disclosure; and

FIG. 4B and FIG. 4C are sectional views of different filter units of the electronic device according to the fourth embodiment of this disclosure.

### DETAILED DESCRIPTION OF THE DISCLOSURE

It should be understood that the following description provides different embodiments for implementing different aspects of some embodiments of the present disclosure. The specific components and arrangements described below are used to briefly and clearly describe some embodiments of the present disclosure. These embodiments are for illustration and are not intended to limit the scope of the present disclosure. In addition, in order to clearly describe this disclosure, similar and/or corresponding reference numbers may be used to indicate similar and/or corresponding elements in different embodiments. These similar and/or corresponding reference numbers are for the purpose of simply and clearly describing some embodiments of the present disclosure, and do not represent any correlation between the different embodiments and/or structures discussed.

It should be understood that embodiments may use relative terms, such as “lower” and “higher” or “bottom” and “top”, to describe the relative relationship of one element to another element shown in the drawings. To be understood, if the device in the drawings is turned upside down, the element described as being at the “lower” side would then be at the “higher” side. Some embodiments of the present disclosure can be understood together with the drawings, and the drawings of the embodiments of the present disclosure are also regarded as part of the description of the embodiments of the present disclosure. It should be understood that the drawings of the embodiments of the present disclosure are not drawn to the actual scale of devices and components. In fact, the dimensions of elements may be arbitrarily enlarged or reduced in order to clearly illustrate features of the present disclosure.

When one structure (or layer, component, or substrate) described in this disclosure is on/above another structure (or layer, component, or substrate), it may mean that the two structures are adjacent and directly connected, or it may mean that the two structures are adjacent and indirectly connected. When the two structures are indirectly connected, it means that there is at least one intermediary structure (or intermediary layer, intermediary component, intermediary substrate, or intermediary spacer) between the two structures. The lower surface of one structure is adjacent to or directly connected to the upper surface of the intermediary structure, and the upper surface of another structure is adjacent to or directly connected to the lower surface of the intermediate structure. The intermediary structure can be composed of a single-layer or multi-layer physical structure or non-physical structure, and there is no limit. In this disclosure, when a structure is disposed “on” another structure, it may mean that the structure is “directly” on the other structure, or that the structure is “indirectly” on the other structure, which means that at least one additional structure is provided between the two structures.

It should be understood that the ordinal numbers used in the specification and claims, such as “first”, “second”, etc., are used to modify elements, but do not themselves imply or represent that the element(s) with the previous ordinal number(s) is/are existed, and do not represent the order between one element and another element in position or in the manufacturing method. These ordinal numbers are only used to make a clear distinction between one element with a certain name and another element with the same name. The claims and the specification may not use the same terms. For example, a first element in the specification may be a second element in the claims.

In some embodiments of this disclosure, the terms related to joining and connecting, such as “connection” and “interconnection”, unless otherwise defined, can mean that two structures are in direct contact, or they can mean that two structures are not in direct contact, and there are one or more other structures arranged therebetween. In addition, the terms related to joining and connecting can include the situation where both structures are movable, or both structures are fixed. In addition, the terms “electrical connection” or “coupling” include any direct and indirect means of electrical connection.

In the contents, the terms “about”, “substantially” and “mostly” usually mean the variation within 10%, 5%, 3%, 2%, 1% or 0.5% of a given value or range. Unless otherwise stated, the phrase “a range between a first value and a second value” means that the range includes the first value, the second value, and other values therebetween. Furthermore, any two numerical values or directions used for comparison may have certain errors. If a first value is equal to a second value, it implies that there may be an error of about 10% between the first value and the second value. If a first direction is perpendicular to a second direction, the included angle between the first direction and the second direction can be between 80 degrees and 100 degrees. If a first direction is parallel to a second direction, the angle between the first direction and the second direction can be between 0 degrees and 10 degrees. In the present disclosure, the terms “a given range from a first value to a second value” and “a given range between a first value and a second value” mean that the given range includes the first value, the second value, and other values there between.

According to embodiments of the present disclosure, the thickness, length and/or width of each element, or the distance and/or angle between the elements can be measured by an optical microscope (OM), a scanning electron microscope (SEM), a film thickness profilometer (α-step), an ellipsometer, or any of other suitable measuring method. Specifically, according to some embodiments, an SEM scanning electron microscope can be used to obtain the cross-sectional image of the structure and to measure the thickness, length, and/or width of each element or the distance and/or angle between the elements.

Throughout the specification and claims of this disclosure, certain words can be used to refer to specific elements. It should be understood by those skilled in the art that the electronic device manufacturers may refer to the same element by different names. This disclosure is not intended to differentiate between components that have the same function but have different names. In the following description and claims, words such as “include”, “comprise”, and “have” are open-ended phrases, and therefore they should be interpreted to mean “including but not limited to . . . ”. Therefore, when the terms “include”, “comprise”, and/or “have” are used in the description of the present disclosure, they specify the presence of the corresponding features, regions, steps, operations, and/or elements, but do not exclude the presence of one or more of corresponding features, regions, steps, operations and/or elements.

To be understood, the features in several different embodiments can be replaced, reorganized, and combined without departing from the spirit of the present disclosure to complete other embodiments. Features of various embodiments may be combined arbitrarily as long as they do not violate or conflict with the spirit of the disclosure.

Unless otherwise defined, all terms (including technical and scientific terms) used herein have the same meaning as commonly understood by the skilled person in the art of this disclosure. It is understood that, unless otherwise defined in the embodiments of this disclosure, these terms, such as those defined in commonly used dictionaries, should be interpreted to have a meaning consistent with the relevant technology and the background or context of the present disclosure, and should not be interpreted in an idealized or overly formal manner. The present disclosure can be understood by referring to the following detailed description in combination with the accompanying drawings. It should be noted that, in order to make it easy for readers to understand and for the simplicity of the drawings, the multiple drawings in the present disclosure only depict a part of the electronic device, and certain elements in the drawings are not drawn to actual scale. In addition, the number and size of elements in the drawings are only for illustrations and are not intended to limit the scope of the present disclosure.

Throughout the specification and claims of this disclosure, certain words can be used to refer to specific elements. It should be understood by those skilled in the art that the electronic device manufacturers may refer to the same element by different names. This disclosure is not intended to differentiate between components that have the same function but have different names.

The electronic device of the present disclosure may include electronic elements. Electronic elements may include passive elements, active elements, or their combinations, such as capacitors, resistors, inductors, varactor diodes, variable capacitors, filters, diodes, transistors, sensors, microelectromechanical system (MEMS) elements, liquid crystal chips, and the likes, but this disclosure is not limited thereto. Diodes may include light-emitting diodes or non-light-emitting diodes. Diodes include P-N junction diodes, PIN diodes or constant current diodes. Light-emitting diodes may include, for example but not limited to, organic light-emitting diodes (OLEDs), mini LEDs, micro LEDs, QLEDs, or LEDs made of fluorescence, phosphor, or other suitable materials, or a combination thereof. Sensors may include, for example but not limited to, capacitive sensors, optical sensors, electromagnetic sensors, fingerprint sensors (FPS), touch sensors, antennas, stylus (pen sensor), or the likes. In the following embodiments, the electronic device is, for example, a display device, but this disclosure is not limited thereto.

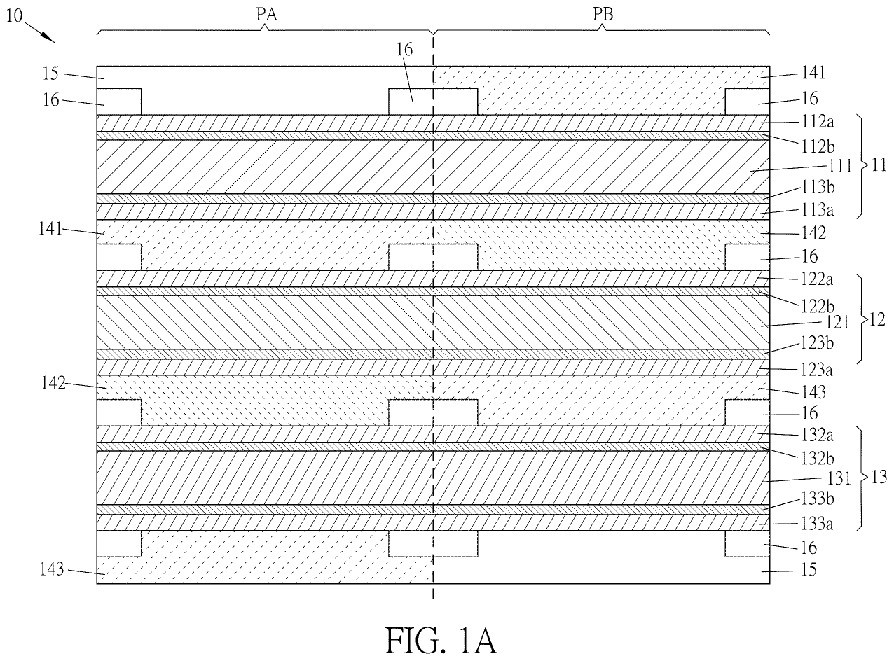

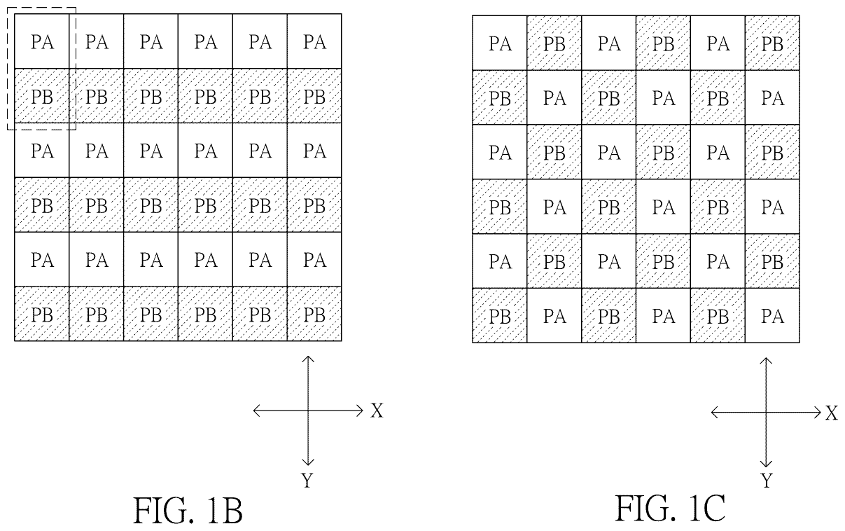

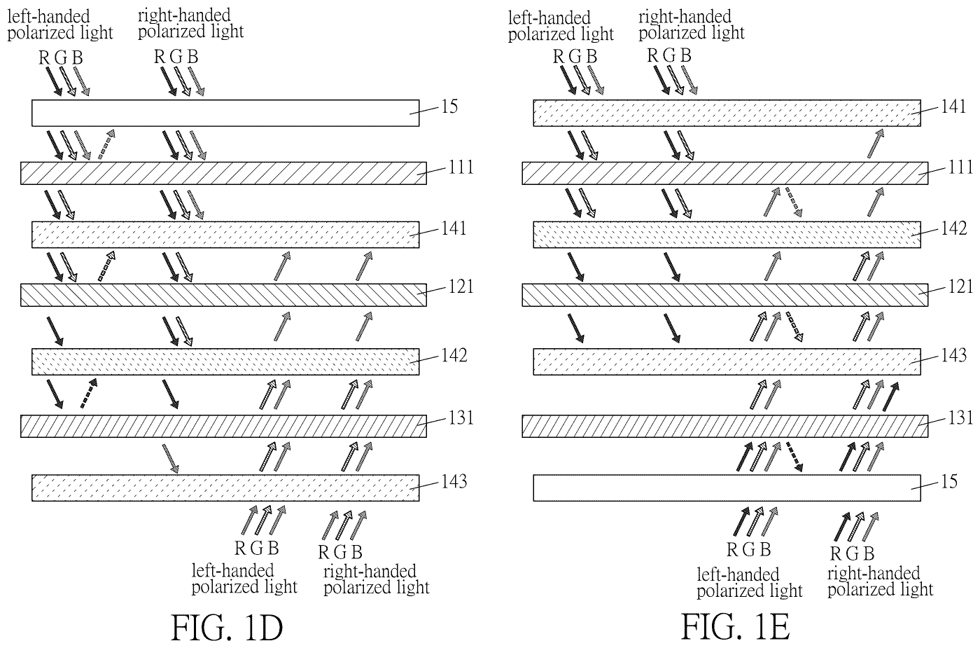

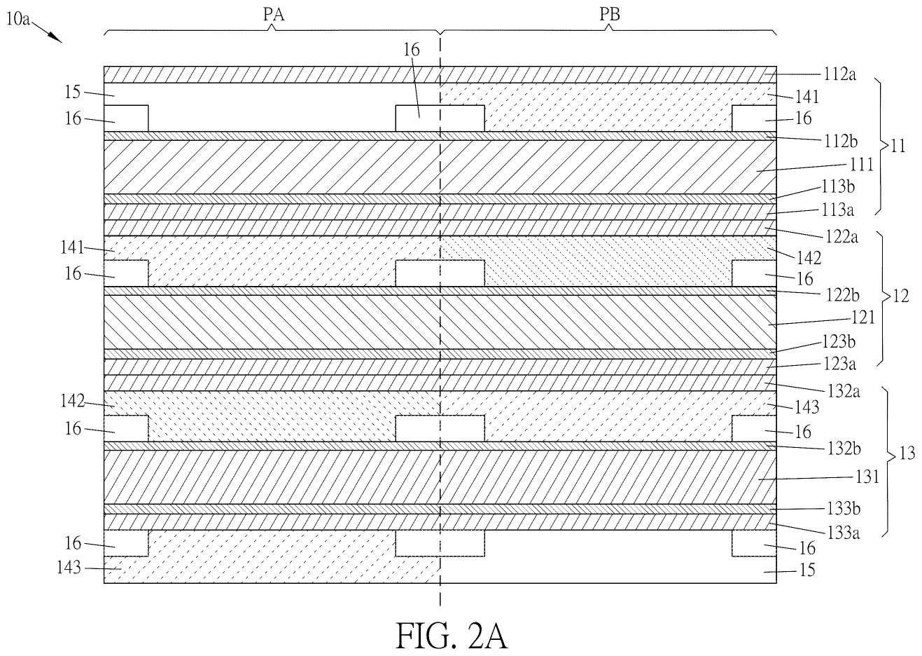

The electronic device may include, for example but not limited to, an imaging device, a laminating device, a display device, a backlight device, an antenna device, a sensing device, a tiled device, a touch display device, a curved display device, or a free shape display device. The electronic device may include, for example but not limited to, liquid crystals, light-emitting diodes, fluorescence elements, phosphor elements, any of other suitable display media, or any combination thereof. The display device may be a non-self-luminous display device or a self-luminous display device. The antenna device may be a liquid crystal based antenna device or a non-liquid crystal based antenna device. The sensing device may be a sensing device that senses capacitance, light, heat or ultrasonic waves, but this disclosure is not limited thereto. The tiled device may be, for example but not limited to, a tiled display device or a tiled antenna device. It should be noted that the electronic device can be any combination of the above, and this disclosure is not limited thereto. The electronic device may be a bendable or flexible electronic device. It should be noted that the electronic device can be any combination of the above, and this disclosure is not limited thereto. In addition, the shape of the electronic device may be a rectangular shape, a circular shape, a polygonal shape, a shape with curved edges, or other suitable shapes. The electronic device may include peripheral systems such as the driving system, control system, light source system, shelf system, and/or the likes, to support the display device, antenna device or tiled device. To be understood, the features in several different embodiments can be replaced, reorganized, and combined without departing from the spirit of the present disclosure to complete other embodiments. Features of various embodiments may be combined arbitrarily as long as they do not violate or conflict with the spirit of the disclosure. It should be noted that the technical solutions provided in different embodiments below can be replaced, combined or mixed with each other to constitute another embodiment without violating the spirit of the present disclosure. FIG. 1A is a schematic diagram of an electronic device according to an embodiment of the present disclosure, and FIGS. 1D and 1E are schematic diagrams showing the light absorption and light reflection of an electronic device according to an embodiment of the present disclosure. The electronic device shown in FIGS. 1D and 1E are the same as that of FIG. 1A, and for convenience of explanation, some components of the electronic device are not shown in FIGS. 1D and 1E.

FIG. 1A is a partial sectional view of an electronic device 10 according to a first embodiment of this disclosure. As shown in FIG. 1A, the electronic device 10 includes a first panel 11, a second panel 12, a plurality of first filter units 141, and a plurality of second filter units 142.

In addition, as shown in FIG. 1A, the electronic device 10 of this embodiment may further include a third panel 13, a plurality of third filter units 143, and a plurality of light-transmitting units 15.

In this embodiment, the electronic device 10 can be, for example but not limited to, a cholesteric liquid crystal reflective display device, which has a plurality of pixel areas, and the plurality of pixel areas are divided into a plurality of first regions PA and a plurality of second regions PB. As shown in FIG. 1B, the number of the first regions PA may be the same as or different from the number of the second regions PB. The first region PA may be adjacent to the second region PB. As shown in FIG. 1B, the plurality of first regions PA may, for example, be arranged in multiple rows (the multiple rows may be arranged along the second direction Y), and each row of first regions PA may, for example, include a plurality of first regions PA arranged sequentially along the first direction X. The plurality of second regions PB may, for example, be arranged in multiple rows (the multiple rows may be arranged along the second direction Y), and each row of second regions PB may, for example, include a plurality of second regions PB arranged sequentially along the first direction X. For example, as shown in FIG. 1B, multiple rows of first regions PA and multiple rows of second regions PB are alternately arranged in the second direction Y. In one case, in the second direction Y, the first row includes a plurality of first regions PA, the second row includes a plurality of second regions PB, the third row includes a plurality of first regions PA, the fourth row includes a plurality of second regions PB, and so on. This disclosure is not limited thereto. In another embodiment, as shown in FIG. 1C, a plurality of first regions PA and a plurality of second regions PB are arranged in a stagger manner. That is, the plurality of first regions PA and the plurality of second regions PB are alternately arranged in both the first direction X and the second direction Y.

FIG. 1A only shows a group of adjacent one first region PA and one second region PB. As shown in FIG. 1A, the first panel 11 includes a first cholesteric liquid crystal layer 111 for reflecting a first color light. For example, when the first cholesteric liquid crystal layer 111 is switched to a planer state, it can reflect the first color light. In this embodiment, the waveband of the light reflected by the first cholesteric liquid crystal layer 111 in the planar state can be, for example but not limited to, a blue light waveband, so the first color light is a blue light. In addition, the first panel 11 further includes a substrate 112a, a substrate 113a, an electrode layer 112b, and an electrode layer 113b. The substrate 112a and the substrate 113a are disposed opposite to each other. The electrode layer 112b is disposed between the first cholesteric liquid crystal layer 111 and the substrate 112a, and the electrode layer 113b is disposed between the first cholesteric liquid crystal layer 111 and the substrate 113a. In this embodiment, each of the substrate 112a and the substrate 113a may include a transparent substrate, and the materials of the substrate 112a and the substrate 113a may include transparent or opaque organic materials and/or inorganic materials. The materials of the substrate 112a and the substrate 113a may include rigid materials or flexible materials. The organic materials may include, for example but not limited to, polyimide (PI), polycarbonate (PC), polyethylene terephthalate (PET), liquid crystal polymer (LCP), or other known suitable materials, or any combination thereof. The inorganic materials may include, for example but are not limited to, glass, quartz, sapphire, or ceramics. The material of the electrode layer 112b and the electrode layer 113b may include a transparent conductive material, such as, for example but not limited to, ITO or IZO.

In addition, referring to FIG. 1A, the second panel 12 is disposed at one side of the first panel 11 and includes a second cholesteric liquid crystal layer 121 for reflecting a second color light. For example, when the second cholesteric liquid crystal layer 121 is switched to a planer state, it can reflect the second color light. In this embodiment, the waveband of the light reflected by the second cholesteric liquid crystal layer 121 in the planar state can be, for example but not limited to, a green light waveband, so the second color light is a green light. In addition, the second panel 12 further includes a substrate 122a, a substrate 123a, an electrode layer 122b, and an electrode layer 123b. The substrate 122a and the substrate 123a are disposed opposite to each other. The electrode layer 122b is disposed between the second cholesteric liquid crystal layer 121 and the substrate 122a, and the electrode layer 123b is disposed between the second cholesteric liquid crystal layer 121 and the substrate 123a. In this embodiment, the materials of the substrate 122a and the substrate 123a may refer to the material of the substrate 112a or the substrate 113a, and the materials of the electrode layer 122b and the electrode layer 123b may refer to the material of the electrode layer 112b or the electrode layer 113b.

Moreover, referring to FIG. 1A, the third panel 13 is disposed at one side of the second panel 12 away from the first panel 11. That is, the second panel 12 is disposed between the first panel 11 and the third panel 13. The third panel 13 includes a third cholesterol liquid crystal layer 131 for reflecting a third color light. For example, when the third cholesteric liquid crystal layer 131 is switched to a planer state, it can reflect the third color light. In this embodiment, the waveband of the light reflected by the third cholesteric liquid crystal layer 131 in the planar state can be, for example but not limited to, a red light waveband, so the third color light is a red light. In addition, the third panel 13 further includes a substrate 132a, a substrate 133a, an electrode layer 132b, and an electrode layer 133b. The substrate 132a and the substrate 133a are disposed opposite to each other. The electrode layer 132b is disposed between the third cholesteric liquid crystal layer 131 and the substrate 132a, and the electrode layer 133b is disposed between the third cholesteric liquid crystal layer 131 and the substrate 133a. In this embodiment, the materials of the substrate 132a and the substrate 133a may refer to the material of the substrate 112a or the substrate 113a, and the materials of the electrode layer 132b and the electrode layer 133b may refer to the material of the electrode layer 112b or the electrode layer 113b.

In addition, in this embodiment, the first panel 11 and the second panel 12 can be fixed to each other directly or through one or more intermediate layers, such as, for example but not limited to, a (transparent) adhesive layer, and the second panel 12 and the third panel 13 can be fixed to each other directly or through one or more intermediate layers, such as, for example but not limited to, a (transparent) adhesive layer.

In this embodiment, the electronic device 10 includes a plurality of filter units, including a plurality of first filter units 141, a plurality of second filter units 142, and a plurality of third filter units 143. As shown in FIG. 1A, a plurality of first filter units 141 and a plurality of second filter units 142 are provided between the first panel 11 (the first cholesteric liquid crystal layer 111) and the second panel 12 (the second cholesteric liquid crystal layer 121). The plurality of first filter units 141 are respectively located in a plurality of first regions PA, and the plurality of second filter units 142 are respectively located in a plurality of second regions PB. In addition, a plurality of additional second filter units 142 and a plurality of third filter units 143 are provided between the second panel 12 (the second cholesteric liquid crystal layer 121) and the third panel 13 (the third cholesteric liquid crystal layer 131). The plurality of additional second filter units 142 are respectively located in the plurality of first regions PA, and the plurality of third filter units 143 are respectively located in the plurality of second regions PB. Moreover, a plurality of additional third filter units 143 and a plurality of light-transmitting units 15 are provided at one side of the third panel 13 (the third cholesteric liquid crystal layer 131) away from the second panel 12 (the second cholesteric liquid crystal layer 121). The plurality of additional third filter units 143 are respectively located in the plurality of first regions PA, and the plurality of light-transmitting units 15 are respectively located in the plurality of second regions PB. A plurality of additional first filter units 141 and a plurality of additional light-transmitting units 15 are provided at one side of the first panel 11 (the first cholesteric liquid crystal layer 111) away from the second panel 12 (the second cholesteric liquid crystal layer 121). The plurality of additional first filter units 141 are respectively located in the plurality of second regions PB, and the plurality of additional light-transmitting units 15 are respectively located in the plurality of first regions PA. As shown in FIG. 1A, one of the first regions PA includes, from top to bottom, the following elements: a light-transmitting unit 15, a part of the first panel 11 (the first cholesteric liquid crystal layer 111), a first filter unit 141, a part of the second panel 12 (the second cholesteric liquid crystal layer 121), a second filter unit 142, a part of the third panel 13 (the third cholesteric liquid crystal layer 131), and a third filter unit 143, but this disclosure is not limited thereto. One of the second regions PB includes, from top to bottom, the following elements: a first filter unit 141, a part of the first panel 11 (the first cholesteric liquid crystal layer 111), a second filter unit 142, a part of the second panel 12 (the second cholesteric liquid crystal layer 121), a third filter unit 143, a part of the third panel 13 (the third cholesteric liquid crystal layer 131), and a light-transmitting unit 15, but this disclosure is not limited thereto. The plurality of first filter units 141 and the plurality of additional first filter units 141 are, for example, used to absorb the same color light, and the wavelength range of the absorbed color light is, for example, at least partially overlapped with the wavelength range of the first color light reflected by the first cholesteric liquid crystal layer 111. The plurality of second filter units 142 and the plurality of additional second filter units 142 are, for example, used to absorb the same color light, and the wavelength ranges of the absorbed color light is, for example, at least partially overlapped with the wavelength range of the second color light reflected by the second cholesteric liquid crystal layer 121. The plurality of third filter units 143 and the plurality of additional third filter units 143 are, for example, used to absorb the same color light, and the wavelength range of the absorbed color light is, for example, at least partially overlapped with the wavelength range of the third color light reflected by the third cholesteric liquid crystal layer 131. The plurality of first filter units 141 and the plurality of second filter units 142 are respectively used to absorb different color lights, and the plurality of third filter units 143, the plurality of first filter units 141 and the plurality of second filter units 142 respectively absorb different color lights. In other words, the absorption wavelength of the first filter unit 141, the absorption wavelength of the second filter unit 142, and the absorption wavelength of the third filter unit 143 are different from each other. In one embodiment, the first color light is, for example, a blue light, the second color light is, for example, a green light, and the third color light is, for example, a red light. Accordingly, for example, the first filter unit 141 is configured to absorb the blue light, the second filter unit 142 is configured to absorb the green light, and the third filter unit 143 is configured to absorb the red light. To be noted, the wavelength range of blue light absorbed by the first filter unit 141 may be the same as or slightly different from the wavelength range of the first color light, the wavelength range of green light absorbed by the second filter unit 142 may be the same as or slightly different from the wavelength range of the second color light, and the wavelength range of red light absorbed by the third filter unit 143 may be the same as or slightly different from the wavelength range of the third color light. It should be noted that the above descriptions are only examples and are not intended to limit the scope of the present disclosure, and this disclosure is not limited thereto.

The operations of each pixel area in the electronic device 10 will be described with reference to FIGS. 1D and 1E, wherein FIG. 1D is a schematic diagram showing the traveling path of the ambient light in the first region PA, and FIG. 1E is a schematic diagram showing the traveling path of the ambient light in the second region PB. In this embodiment, as shown in FIG. 1D, the ambient light is first roughly divided into three color lights, including a red light R (the third color light), a green light G (the second color light), and a blue light B (the first color light), and the polarization states of the above-mentioned color lights can be split into left-handed polarized light and right-handed polarized light. To facilitate the description of the operation of the embodiment, the first cholesteric liquid crystal layer 111, the second cholesteric liquid crystal layer 121 and the third cholesteric liquid crystal layer 131 are assumed to include left-handed liquid crystals, but this disclosure is not limited thereto. When the above-mentioned cholesteric liquid crystal layers are in the planar state, they can reflect the color lights (or light of specific wavelength) with the corresponding helical pitches and handedness. For example, the first cholesteric liquid crystal layer 111 in the planar state can reflect the left-handed blue light, the second cholesteric liquid crystal layer 121 in the planar state can reflect the left-handed green light, and the third cholesteric liquid crystal layer 131 in the planar state can reflect the left-handed red light, but this disclosure is not limited thereto. When the (ambient) light is incident from the top side of the first region PA (e.g. adjacent to the light-transmitting unit 15), most of the red light R, the green light G and the blue light B can pass through the light-transmitting unit 15. Then, most of the red light R and the green light G can pass through the first panel 11 (the first cholesteric liquid crystal layer 111) and the first filter unit 141 (the filter unit for absorbing blue light), and the first cholesteric liquid crystal layer 111 can reflect a part of the blue light B (e.g. reflect the left-handed blue light). That is, when the first cholesteric liquid crystal layer 111 is in a planar state, it can reflect the left-handed blue light B, while the other part of blue light B (the right-handed blue light B) can pass through the first cholesteric liquid crystal layer 111. However, the other part of the blue light B (the right-handed blue light B) that passes through the first cholesteric liquid crystal layer 111 will be mostly absorbed by the first filter unit 141 (the filter unit for absorbing blue light) below. Therefore, for example, only most of the red light R and the green light G can pass through the first filter unit 141. Afterwards, most of the red light R can pass through the second panel 12 (the second cholesteric liquid crystal layer 121) and the second filter unit 142 (the filter unit for absorbing green light), and the second cholesteric liquid crystal layer 121 can reflect part of the green light G (e.g. reflect the left-handed green light). That is, when the second cholesteric liquid crystal layer 121 is in a planar state, it can reflect the left-handed green light G, while the other part of green light G (the right-handed green light G) can mostly pass through the second cholesteric liquid crystal layer 121. However, the other part of the green light G (the right-handed green light G) that passes through the second cholesteric liquid crystal layer 121 will be absorbed by the second filter unit 142 (the filter unit for absorbing green light) below. Therefore, for example, only most of the red light R can pass through the second filter unit 142. Then, the third cholesteric liquid crystal layer 131 can reflect part of the red light R (e.g. reflect the left-handed red light). That is, when the third cholesteric liquid crystal layer 131 is in a planar state, it can reflect the left-handed red light R, and the other part of the red light R (the right-handed red light R) can pass through the third cholesteric liquid crystal layer 131. However, the other part of the red light R (the right-handed red light R) that passes through the third cholesteric liquid crystal layer 131 can be, for example, absorbed by the third filter unit 143 (the filter unit for absorbing red light). Therefore, substantially no light can pass through the third filter unit 143 and be displayed toward the bottom side of the electronic device 10. In addition, when the cholesterol liquid crystal layer is in the focal conic state, most of the left-handed or right-handed lights are not reflected by the cholesterol liquid crystal layer. Therefore, for example, the blue light B (including left-handed blue light and/or right-handed blue light) will be mostly absorbed by the first filter unit 141, the green light G (including left-handed green light and/or right-handed green light) will be mostly absorbed by the second filter unit 142, and the red light R (including left-handed red light and/or right-handed red light) will be mostly absorbed by the third filter unit 143. Accordingly, almost none of the incident light can pass through the third filter unit 143 and be displayed toward the bottom side of the electronic device 10.

In addition, when the ambient light is incident from the bottom side of the first region PA of the pixel area (e.g. adjacent to the third filter unit 143), most of the green light G and the blue light B can pass through the third filter unit 143 (the filter unit for absorbing red light) and the third cholesteric liquid crystal layer 131, and most of the red light R can be absorbed by the third filter unit 143 (the filter unit for absorbing red light). Then, most of the blue light B can pass through the second filter unit 142 (the filter unit for absorbing green light) and the second cholesteric liquid crystal layer 121, and most of the green light G can be absorbed by the second filter unit 142 (the filter unit for absorbing green light). Afterwards, most of the blue light B can be absorbed by the first filter unit 141 (the filter unit for absorbing blue light), so the light incident from the bottom side of the first region PA (e.g. adjacent to the third filter unit 143) cannot pass through the first filter unit 141 and be displayed toward the top side of the electronic device 10.

As a result, in this embodiment, the user can view the image displayed by the first regions PA from the top side of the electronic device 10, but the first regions PA does not display image toward the bottom side of the electronic device 10.

In addition, in this embodiment as shown in FIG. 1E, when the ambient light is incident from the bottom side of the second region PB (e.g. adjacent to the light-transmitting unit 15), most of the red light R, the green light G and the blue light B can pass through the light-transmitting unit 15 arranged at the bottom side. Then, most of the green light G and the blue light B can pass through the third panel 13 (the third cholesteric liquid crystal layer 131) and the third filter unit 143 (the filter unit for absorbing red light), and the third cholesteric liquid crystal layer 131 can reflect a part of the red light R (e.g. reflect the left-handed red light R). That is, when the third cholesteric liquid crystal layer 131 is in a planar state, it can reflect the left-handed red light R, while the other part of red light R (the right-handed red light R) can pass through the third cholesteric liquid crystal layer 131. However, the other part of the red light R (the right-handed red light R) that passes through the third cholesteric liquid crystal layer 131 will be mostly absorbed by the third filter unit 143 (the filter unit for absorbing red light). Therefore, for example, only most of the green light G and the blue light B can pass through the third filter unit 143. Afterwards, most of the blue light B can pass through the second panel 12 (the second cholesteric liquid crystal layer 121) and the second filter unit 142 (the filter unit for absorbing green light), and the second cholesteric liquid crystal layer 121 can reflect part of the green light G (e.g. reflect the left-handed green light G). That is, when the second cholesteric liquid crystal layer 121 is in a planar state, it can reflect the left-handed green light G, while the other part of green light G (the right-handed green light G) can mostly pass through the second cholesteric liquid crystal layer 121. However, the other part of the green light G (the right-handed green light G) that passes through the second cholesteric liquid crystal layer 121 will be absorbed by the second filter unit 142 (the filter unit for absorbing green light). Therefore, for example, only most of the blue light B can pass through the second filter unit 142. Then, the first cholesteric liquid crystal layer 111 can reflect part of the blue light B (e.g. reflect the left-handed blue light B). That is, when the first cholesteric liquid crystal layer 111 is in a planar state, it can reflect the left-handed blue light B, and the other part of the blue light B (the right-handed blue light B) can pass through the first cholesteric liquid crystal layer 111. However, the other part of the blue light B (the right-handed blue light B) that passes through the first cholesteric liquid crystal layer 111 can be, for example, absorbed by the first filter unit 141 (the filter unit for absorbing blue light). Therefore, substantially no light can pass through the first filter unit 141 and be displayed toward the top side of the electronic device 10. In addition, when the cholesterol liquid crystal layer is in the focal conic state, most of the left-handed or right-handed lights are not reflected by the cholesterol liquid crystal layer. Therefore, for example, the red light R (including left-handed red light and/or right-handed red light) will be mostly absorbed by the third filter unit 143, the green light G (including left-handed green light and/or right-handed green light) will be mostly absorbed by the second filter unit 142, and the blue light B (including left-handed blue light and/or right-handed blue light) will be mostly absorbed by the first filter unit 141. Accordingly, almost none of the incident light can pass through the first filter unit 141 and be displayed toward the top side of the electronic device 10.

In addition, when the (ambient) light is incident from the top side of the second region PB of the pixel area (e.g. adjacent to the first filter unit 141), most of the green light G and the red light R can pass through the first filter unit 141 (the filter unit for absorbing blue light) and the first cholesteric liquid crystal layer 111, and most of the blue light R can be absorbed by the first filter unit 141 (the filter unit for absorbing blue light). Then, most of the red light R can pass through the second filter unit 142 (the filter unit for absorbing green light) and the second cholesteric liquid crystal layer 121, and most of the green light G can be absorbed by the second filter unit 142 (the filter unit for absorbing green light). Afterwards, most of the red light R can be absorbed by the third filter unit 143 (the filter unit for absorbing red light), so the light incident from the top side of the second region PB cannot pass through the third filter unit 143 and be displayed toward the bottom side of the electronic device 10.

As a result, in this embodiment, the user can view the image displayed by the second regions PB from the bottom side of the electronic device 10, but the second regions PB does not display image toward the top side of the electronic device 10.

Furthermore, in the embodiment as shown in FIG. 1A, the electronic device 10 may further include a plurality of light-shielding elements 16, disposed between the first cholesteric liquid crystal layer 111 and the second cholesteric liquid crystal layer 121. In the top-view direction of the electronic device 10, one of the plurality of light-shielding elements 16 overlaps a boundary area between one of a plurality of first filter units 141 and adjacent one of a plurality of second filter units 142. A plurality of additional light-shielding elements 16 are disposed between the second cholesteric liquid crystal layer 121 and the third cholesteric liquid crystal layer 131. In the top-view direction of the electronic device 10, one of the plurality of light-shielding elements 16 overlaps a boundary area between one of a plurality of second filter units 142 and adjacent one of a plurality of third filter units 143. A plurality of additional light-shielding elements 16 are disposed at one side of the third cholesteric liquid crystal layer 131 away from the second cholesteric liquid crystal layer 121. In the top-view direction of the electronic device 10, one of the plurality of light-shielding elements 16 overlaps a boundary area between one of a plurality of third filter units 143 and adjacent one of a plurality of light-transmitting units 15. A plurality of additional light-shielding elements 16 are disposed at one side of the first cholesteric liquid crystal layer 111 away from the second cholesteric liquid crystal layer 121. In the top-view direction of the electronic device 10, one of the plurality of light-shielding elements 16 overlaps a boundary area between one of a plurality of light-transmitting units 15 and adjacent one of a plurality of first filter units 141. In other words, each light-shielding element 16 is, for example, disposed at the boundary area between two adjacent filter units or at the boundary area between one filter unit and the adjacent light-transmitting unit 15. That is, each light-shielding element 16 is, for example, disposed at the boundary area between the first region PA and the second region PB. In one embodiment, the light-shielding element 16 may, for example, include a black matrix layer or any of other light-shielding elements, and the disclosure is not limited thereto.

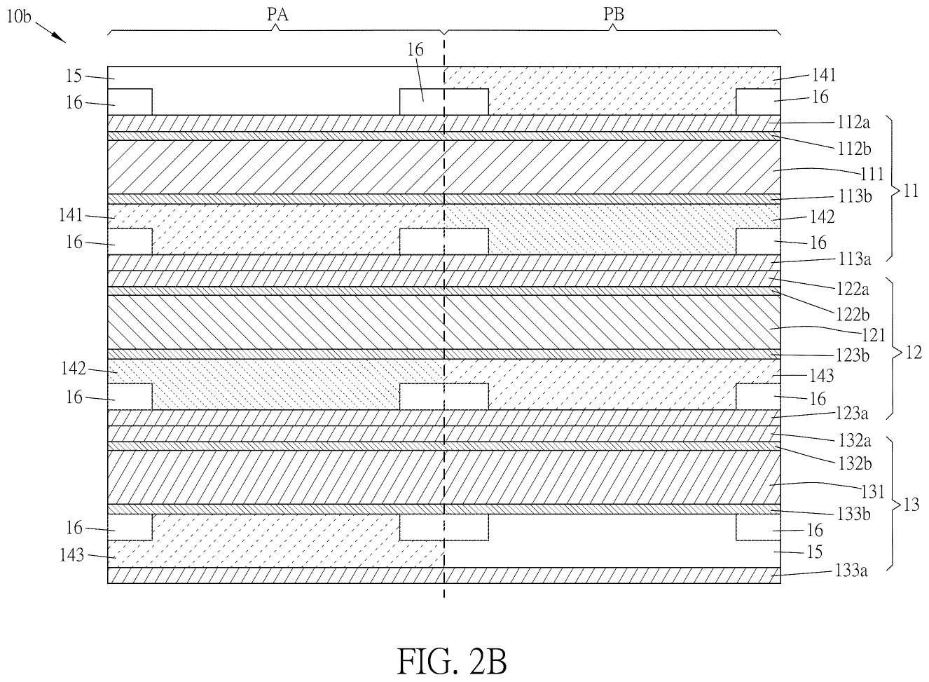

FIG. 2A and FIG. 2B are partial sectional views of different aspects of electronic devices according to a second embodiment of this disclosure.

The component configurations and connections of the electronic device 10a of this embodiment as shown in FIG. 2A are mostly the same as those of the electronic device 10 of the previous embodiment. Unlike the previous embodiment, in the electronic device 10a as shown in FIG. 2A, the light-transmitting unit 15 and the first filter unit 141 (a filter unit for absorbing blue light) disposed above the first cholesteric liquid crystal layer 111 may, for example, be configured inside the first panel 11, the first filter unit 141 (a filter unit for absorbing blue light) and the second filter unit 142 (a filter unit for absorbing green light) disposed above the second cholesteric liquid crystal layer 121 may, for example, be configured inside the second panel 12, and the second filter unit 142 (a filter unit for absorbing green light) and the third filter unit 143 (a filter unit for absorbing red light) disposed above the third cholesteric liquid crystal layer 131 may, for example, be configured inside the third panel 13. This disclosure is not limited thereto. Specifically, in the first panel 11, the light-transmitting unit 15 and the first filter unit 141 are disposed between the substrate 112a and the electrode layer 112b, wherein the light transmitting unit 15 is correspondingly disposed in the first region PA, and the first filter unit 141 is correspondingly disposed in the second region PB. In the second panel 12, the first filter unit 141 and the second filter unit 142 are disposed between the substrate 122a and the electrode layer 122b, wherein the first filter unit 141 is correspondingly disposed in the first region PA, and the second filter unit 142 is correspondingly disposed in the second region PB. In the third panel 13, the second filter unit 142 and the third filter unit 143 are disposed between the substrate 132a and the electrode layer 132b, wherein the second filter unit 142 is correspondingly disposed in the first region PA, and the third filter unit 143 is correspondingly disposed in the second region PB.

To be noted, the other details of the electronic device 10a of this embodiment can be referred to the above embodiment, so the detailed descriptions thereof will be omitted.

The component configurations and connections of the electronic device 10b of this embodiment as shown in FIG. 2B are mostly the same as those of the electronic device 10 of the previous embodiment. Unlike the previous embodiment, in the electronic device 10b as shown in FIG. 2B, the first filter unit 141 and the second filter unit 142 disposed below the first cholesteric liquid crystal layer 111 may be configured inside the first panel 11, the second filter unit 142 and the third filter unit 143 disposed below the second cholesteric liquid crystal layer 121 may be configured inside the second panel 12, and the third filter unit 143 and the light-transmitting unit 15 disposed below the third cholesteric liquid crystal layer 131 may be configured inside the third panel 13. Specifically, in the first panel 11, the first filter unit 141 and the second filter unit 142 are disposed between the substrate 113a and the electrode layer 113b, wherein the first filter unit 141 is correspondingly disposed in the first region PA, and the second filter unit 142 is correspondingly disposed in the second region PB. In the second panel 12, the second filter unit 142 and the third filter unit 143 are disposed between the substrate 123a and the electrode layer 123b, wherein the second filter unit 142 is correspondingly disposed in the first region PA, and the third filter unit 143 is correspondingly disposed in the second region PB. In the third panel 13, the third filter unit 143 and the light-transmitting unit 15 are disposed between the substrate 133a and the electrode layer 133b, wherein the third filter unit 143 is correspondingly disposed in the first region PA, and the light-transmitting unit 15 is correspondingly disposed in the second region PB.

To be noted, the other details of the electronic device 10b of this embodiment can be referred to the above embodiment, so the detailed descriptions thereof will be omitted.

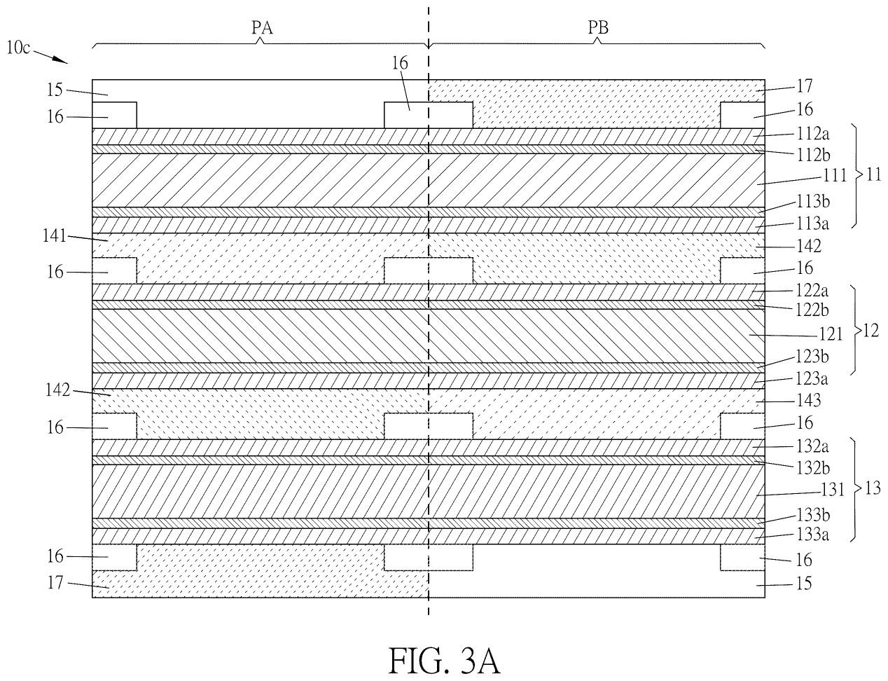

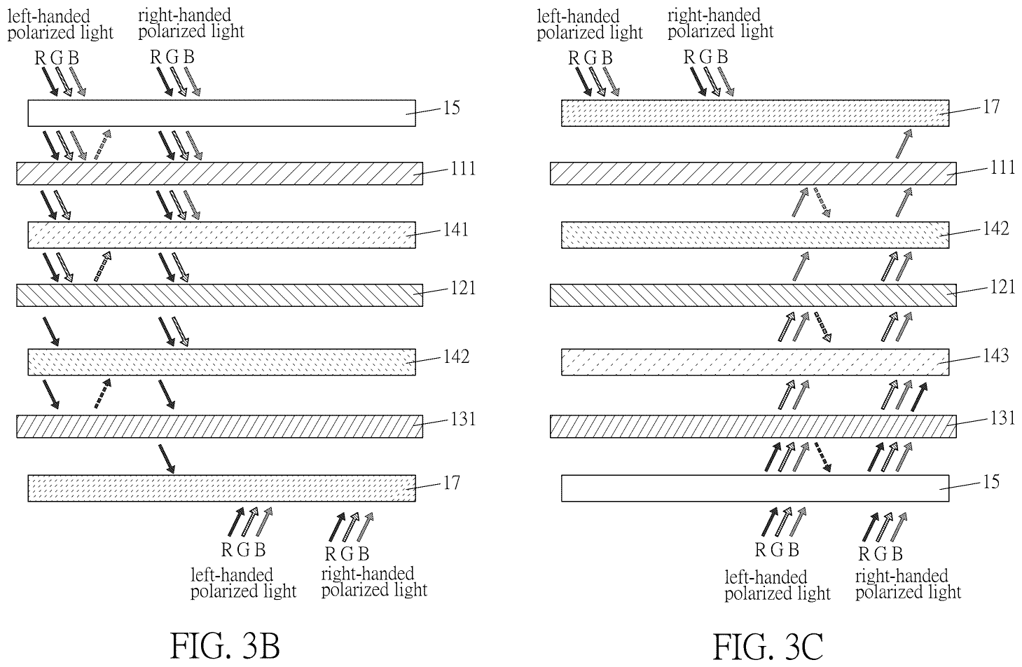

FIG. 3A is a partial sectional view of an electronic device according to a third embodiment of this disclosure.

The component configurations and connections of the electronic device 10c of this embodiment as shown in FIG. 3A are mostly the same as those of the electronic device 10 of the previous embodiment. Unlike the previous embodiment, as shown in FIG. 3A, the electronic device 10c is provided with a plurality of light-shielding units 17 to replace part of the third filter units 143 located under the third cholesteric liquid crystal layer 131 or to replace part of the first filter unit 141 located above the first cholesteric liquid crystal 111. For example, a plurality of light-shielding units 17 can be disposed at one side of the third cholesteric liquid crystal layer 131 away from the second cholesteric liquid crystal layer 121, and are respectively located in the plurality of first regions PA. In this case, a plurality of light-transmitting units 15 are disposed at one side of the third cholesteric liquid crystal layer 131 away from the second cholesteric liquid crystal layer 121, and are respectively located in a plurality of second regions PB. In addition, a plurality of light-shielding units 17 may be disposed at one side of the first cholesteric liquid crystal layer 111 away from the second cholesteric liquid crystal layer 121, and respectively located in a plurality of second regions PB. In this case, a plurality of light-transmitting units 15 are disposed at one side of the first cholesteric liquid crystal layer 111 away from the second cholesteric liquid crystal layer 121, and are respectively located in a plurality of first regions PA. In this embodiment, the light-shielding unit 17 may include, for example, a black absorption layer. In this case, the light-shielding unit 17 may, for example, include a material for absorbing a visible light waveband (e.g. a waveband of 380 nm to 780 nm), so that the contrast of the displayed image of the electronic device 10c can be improved.

The operations of each pixel area in the electronic device 10c will be described with reference to FIGS. 3B and 3C, wherein FIG. 3B is a schematic diagram showing the traveling path of the (ambient) light in the first region PA, and FIG. 3C is a schematic diagram showing the traveling path of the (ambient) light in the second region PB. In this embodiment, as shown in FIG. 3B, the ambient light is first roughly divided into three color lights, including a red light R (the third color light), a green light G (the second color light), and a blue light B (the first color light), and the polarization states of the above-mentioned color lights can be split into left-handed polarized light and right-handed polarized light. To facilitate the description of the operation of the embodiment, the first cholesteric liquid crystal layer 111, the second cholesteric liquid crystal layer 121 and the third cholesteric liquid crystal layer 131 are assumed to include left-handed liquid crystals, but this disclosure is not limited thereto. When the above-mentioned cholesteric liquid crystal layers are in the planar state, they can reflect the color lights (or light of specific wavelength) with the corresponding helical pitches and handedness. For example, the first cholesteric liquid crystal layer 111 in the planar state can reflect the left-handed blue light, the second cholesteric liquid crystal layer 121 in the planar state can reflect the left-handed green light, and the third cholesteric liquid crystal layer 131 in the planar state can reflect the left-handed red light, but this disclosure is not limited thereto. When the (ambient) light is incident from the top side of the first region PA (e.g. adjacent to the light-transmitting unit 15), most of the red light R, the green light G and the blue light B can pass through the light-transmitting unit 15. Then, most of the red light R and the green light G can pass through the first panel 11 (the first cholesteric liquid crystal layer 111) and the first filter unit 141 (the filter unit for absorbing blue light), and the first cholesteric liquid crystal layer 111 can reflect a part of the blue light B (e.g. reflect the left-handed blue light). That is, when the first cholesteric liquid crystal layer 111 is in a planar state, it can reflect the left-handed blue light B, while the other part of blue light B (the right-handed blue light B) can pass through the first cholesteric liquid crystal layer 111. However, the other part of the blue light B (the right-handed blue light B) that passes through the first cholesteric liquid crystal layer 111 will be mostly absorbed by the first filter unit 141 (the filter unit for absorbing blue light) below. Therefore, for example, only most of the red light R and the green light G can pass through the first filter unit 141. Afterwards, most of the red light R can pass through the second panel 12 (the second cholesteric liquid crystal layer 121) and the second filter unit 142 (the filter unit for absorbing green light), and the second cholesteric liquid crystal layer 121 can reflect part of the green light G (e.g. reflect the left-handed green light). That is, when the second cholesteric liquid crystal layer 121 is in a planar state, it can reflect the left-handed green light G, while the other part of green light G (the right-handed green light G) can mostly pass through the second cholesteric liquid crystal layer 121. However, the other part of the green light G (the right-handed green light G) that passes through the second cholesteric liquid crystal layer 121 will be absorbed by the second filter unit 142 (the filter unit for absorbing green light) below. Therefore, for example, only most of the red light R can pass through the second filter unit 142. Then, the third cholesteric liquid crystal layer 131 can reflect part of the red light R (e.g. reflect the left-handed red light). That is, when the third cholesteric liquid crystal layer 131 is in a planar state, it can reflect the left-handed red light R, and the other part of the red light R (the right-handed red light R) can mostly pass through the third cholesteric liquid crystal layer 131. However, the other part of the red light R (the right-handed red light R) that passes through the third cholesteric liquid crystal layer 131 can be, for example, absorbed by the light-shielding unit 17 below. Therefore, substantially no light can pass through the light-shielding unit 17 and be displayed toward the bottom side of the electronic device 10c. In addition, when the cholesterol liquid crystal layer is in the focal conic state, most of the left-handed or right-handed lights are not reflected by the cholesterol liquid crystal layer. Therefore, for example, the blue light B (including left-handed blue light and/or right-handed blue light) will be mostly absorbed by the first filter unit 141, the green light G (including left-handed green light and/or right-handed green light) will be mostly absorbed by the second filter unit 142, and the red light R (including left-handed red light and/or right-handed red light) will be mostly absorbed by the light-shielding unit 17 disposed under the third cholesteric liquid crystal layer 131. Accordingly, almost none of the incident light can pass through the light-shielding unit 17 and be displayed toward the bottom side of the electronic device 10c.

In addition, when the (ambient) light is incident from the bottom side of the first region PA of the pixel area (e.g. adjacent to the light-shielding unit 17), the red light R (including left-handed red light and/or right-handed red light), the green light G (including left-handed green light and/or right-handed green light), and the blue light B (including left-handed blue light and/or right-handed blue light) will be mostly absorbed by the light-shielding unit 17 below. Therefore, the light incident from the bottom side of the first region PA cannot pass through the light-shielding unit 17 and be displayed toward the top side of the electronic device 10c.

As a result, in this embodiment, the user can view the image displayed by the first regions PA from the top side of the electronic device 10c, but the first regions PA does not display image toward the bottom side of the electronic device 10c.

In addition, in this embodiment as shown in FIG. 3C, when the (ambient) light is incident from the bottom side of the second region PB (e.g. adjacent to the light-transmitting unit 15), most of the red light R, the green light G and the blue light B can pass through the light-transmitting unit 15 arranged at the bottom side. Then, most of the green light G and the blue light B can pass through the third panel 13 (the third cholesteric liquid crystal layer 131) and the third filter unit 143 (the filter unit for absorbing red light), and the third cholesteric liquid crystal layer 131 can reflect a part of the red light R (e.g. reflect the left-handed red light R). That is, when the third cholesteric liquid crystal layer 131 is in a planar state, it can reflect the left-handed red light R, while the other part of red light R (the right-handed red light R) can pass through the third cholesteric liquid crystal layer 131. However, the other part of the red light R (the right-handed red light R) that passes through the third cholesteric liquid crystal layer 131 will be mostly absorbed by the third filter unit 143 (the filter unit for absorbing red light). Therefore, for example, only most of the green light G and the blue light B can pass through the third filter unit 143. Afterwards, most of the blue light B can pass through the second panel 12 (the second cholesteric liquid crystal layer 121) and the second filter unit 142 (the filter unit for absorbing green light), and the second cholesteric liquid crystal layer 121 can reflect part of the green light G (e.g. reflect the left-handed green light G). That is, when the second cholesteric liquid crystal layer 121 is in a planar state, it can reflect the left-handed green light G, while the other part of green light G (the right-handed green light G) can mostly pass through the second cholesteric liquid crystal layer 121. However, the other part of the green light G (the right-handed green light G) that passes through the second cholesteric liquid crystal layer 121 will be absorbed by the second filter unit 142 (the filter unit for absorbing green light). Therefore, for example, only most of the blue light B can pass through the second filter unit 142. Then, the first cholesteric liquid crystal layer 111 can reflect part of the blue light B (e.g. reflect the left-handed blue light B). That is, when the first cholesteric liquid crystal layer 111 is in a planar state, it can reflect the left-handed blue light B, and the other part of the blue light B (the right-handed blue light B) can pass through the first cholesteric liquid crystal layer 111. However, the other part of the blue light B (the right-handed blue light B) that passes through the first cholesteric liquid crystal layer 111 can be, for example, absorbed by the light-shielding unit 17. Therefore, substantially no light can pass through the light-shielding unit 17 and be displayed toward the top side of the electronic device 10c. In addition, when the cholesterol liquid crystal layer is in the focal conic state, most of the left-handed or right-handed lights are not reflected by the cholesterol liquid crystal layer. Therefore, for example, the red light R (including left-handed red light and/or right-handed red light) will be mostly absorbed by the third filter unit 143, the green light G (including left-handed green light and/or right-handed green light) will be mostly absorbed by the second filter unit 142, and the blue light B (including left-handed blue light and/or right-handed blue light) will be mostly absorbed by the light-shielding unit 17 disposed above the first cholesteric liquid crystal layer 111. Accordingly, almost none of the incident light can pass through the light-shielding unit 17 and be displayed toward the top side of the electronic device 10c.

In addition, when the (ambient) light is incident from the top side of the second region PB of the pixel area (e.g. adjacent to the light-shielding unit 17), the blue light B (including left-handed blue light and/or right-handed blue light), the green light G (including left-handed green light and/or right-handed green light), and the red light R (including left-handed red light and/or right-handed red light) will be mostly absorbed by the light-shielding unit 17. Therefore, the light incident from the top side of the second region PB cannot pass through the light-shielding unit 17 and be displayed toward the bottom side of the electronic device 10c.

As a result, in this embodiment, the user can view the image displayed by the second regions PB from the bottom side of the electronic device 10c, but the second regions PB does not display image toward the top side of the electronic device 10c.

To be noted, the feature of this embodiment (the third embodiment) that uses the light-shielding unit 17 to replace part of the third filter units 143 and part of the first filter units 141 can be applied to the aforementioned first embodiment and/or the second embodiment. The present disclosure is not limited thereto.

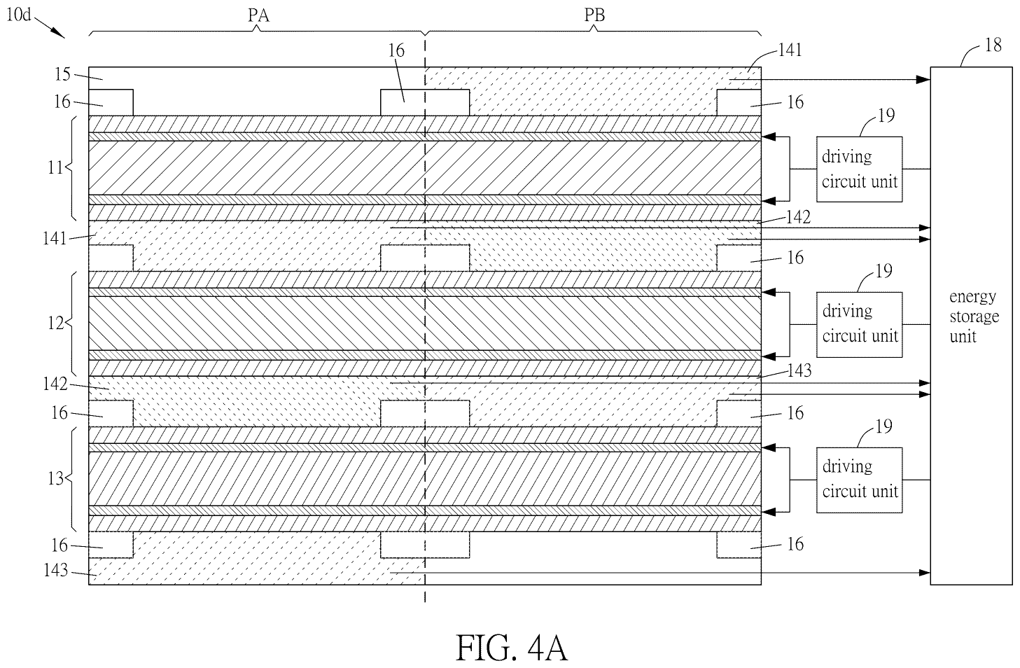

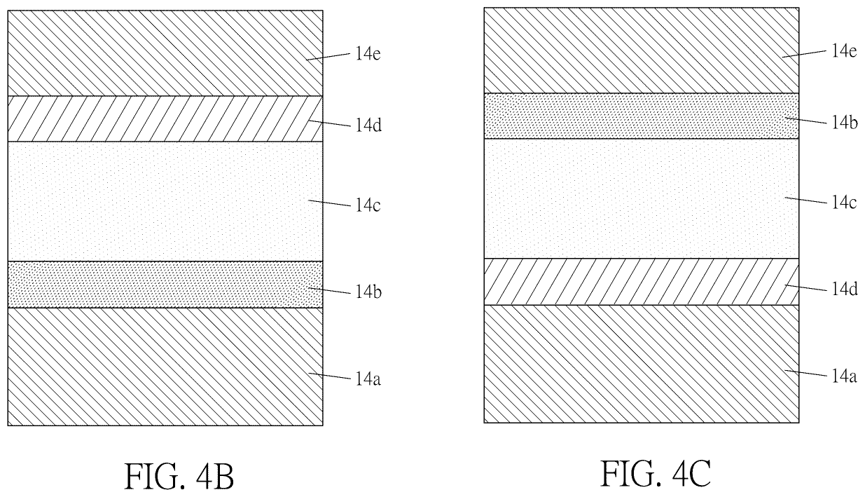

FIG. 4A is a partial sectional view of an electronic device 10d according to a fourth embodiment of this disclosure.

The component configurations and connections of the electronic device 10d of this embodiment as shown in FIG. 4A are mostly the same as those of the electronic device 10 of the previous embodiment. Unlike the previous embodiment, in the electronic device 10d as shown in FIG. 4A, at least one of a plurality of first filter units 141, a plurality of second filter units 142 and a plurality of third filter units 143 includes a solar cell. The solar cell may be, for example but not limited to, a perovskite solar cell (PSC) or a dye-sensitized solar cell (DSC). For example, in this embodiment, the first filter unit 141 is a filter unit for absorbing blue light, the second filter unit 142 is a filter unit for absorbing green light, and the third filter unit 143 is a filter unit for absorbing red light. Therefore, the material of the first filter unit 141 may include the material of a perovskite solar cell or a dye-sensitized solar cell that can absorb blue light wavelength, the material of the second filter unit 142 may include the material of a perovskite solar cell or a dye-sensitized solar cell that can absorb green light wavelength, and the material of the third filter unit 143 may include the material of a perovskite solar cell or a dye-sensitized solar cell that can absorb red light wavelength. This disclosure is not limited thereto.

In one embodiment, taking a perovskite solar cell as an example, the perovskite solar cell includes a perovskite layer as the light-absorbing layer (i.e., the active layer) of the solar cell. Since the perovskite material has good light absorption of visible light and a wide absorption range, it can not only generate high short-circuit current by using a small amount of the perovskite material, but also enables the battery component to have a high open-circuit voltage. Therefore, the perovskite solar cells have excellent power conversion efficiency (PCE). Generally speaking, the perovskite is a crystal material with a general chemical formula of ABX 3. In the perovskite crystal structure, A denotes a larger cation, B denotes a smaller cation, and X denotes an anion. Each cation A is surrounded by an octahedron composed of the cation B and the anions X. The cation A sits at the cube corner position of the cubic lattice, and can generally be, for example but not limited to, methylammonium (MA), ethylammonium (EA), formamidine (FA), Cs, Rb, or the likes. The cation B sits at the body-center position of the cubic lattice, and can generally be, for example but not limited to, Pb ion, Sn ion, or the likes. The anions X sit at the face centered positions of the cubic lattice, and can generally be oxygen, halogen (e.g. Cl, Br, I), or the likes.

It should be noted that these perovskite materials have the characteristics such as adjustable band gap width, high extinction coefficient and good light absorption. This embodiment utilizes the characteristics of adjustable band gap width of perovskite materials and selects proper elements A, B and X to adjust the light wavelength (waveband) to be absorbed for forming the first filter units 141, the second filter units 142 and the third filter units 143. Accordingly, the first filter units 141 can absorb the blue light and convert it into electrical energy, the second filter units 142 can absorb the green light and convert it into electrical energy, and the third filter units 143 can absorb the red light and convert it into electrical energy. It should be noted that the above descriptions are only examples and are not intended to limit the scope of the present disclosure, and the present disclosure is not limited thereto.

As mentioned above, when the filter unit includes a solar cell (e.g. a perovskite solar cell), its structure may be as shown in FIG. 4B or FIG. 4C, but this disclosure is not limited thereto. As shown in FIG. 4B, the filter unit may include a conductive layer 14a, an electron transport layer 14b, a light absorption layer 14c, a hole transport layer 14d, and a conductive layer 14e. This structure can be referred to an n-i-p planar perovskite solar cell. In this case, the conductive layer 14a can be a transparent conductive layer, such as a transparent conductive substrate, which includes, for example but not limited to, an ITO substrate, an FTO substrate, or any of other transparent conductive substrates. The electron transport layer 14b is disposed on the conductive layer 14a, and the material thereof can be, for example but not limited to, cesium carbonate (Cs₂CO₃), titanium dioxide (TiO₂), zinc oxide (ZnO), PFN, zirconium oxide (ZrO), or any of other materials suitable for transporting electrons in this structure. The light absorption layer 14c is disposed on the electron transport layer 14b, and the material thereof can be, for example but not limited to, the aforementioned perovskite material. The hole transport layer 14d is disposed on the light absorption layer 14c, and the material thereof can be, for example but not limited to, vanadium pentoxide (V₂O₅), Spiro-OMeTAD, nickel oxide (NiO), tungsten trioxide (WO₃), molybdenum trioxide (MoO₃), or any of other materials suitable for transporting holes in this structure. The conductive layer 14e is disposed on the hole transport layer 14d, and the material thereof can be, for example but not limited to, a transparent conductive layer.

In another case as shown in FIG. 4C, the filter unit may include a conductive layer 14a, a hole transport layer 14d, a light absorption layer 14c, an electron transport layer 14b, and a conductive layer 14e. This structure can be referred to a p-i-n planar perovskite solar cell.

In this embodiment, as shown in FIG. 4A, the electronic device 10d may further include an energy storage unit 18, which is electrically connected to the first filter unit(s) 141, the second filter unit(s) 142, and/or the third filter unit(s) 143, for storing the electric energy generated by the first filter unit(s) 141, the second filter unit(s) 142, and/or the third filter unit(s) 143. In addition, the electronic device 10d may further include one or more driving circuit units 19, which may each include, for example, a signal conversion circuit and are electrically connected to the first panel 11, the second panel 12 and the third panel 13 respectively for driving the first panel 11, the second panel 12 and the third panel 13 to operate. In this embodiment, the driving circuit unit 19 can be electrically connected to the energy storage unit 18, so that the energy storage unit 18 can provide the electric energy to the driving circuit unit 19 for driving the first panel 11, the second panel 12 and/or the third panel 13. Therefore, the electronic device 10d of this embodiment can generate and store electric energy during the displaying period.

To be noted, this embodiment (the fourth embodiment) applies the feature that the filter unit includes a solar cell to the first embodiment. In other cases, this feature can also be applied to any of the aforementioned embodiments, such as the second embodiment or the third embodiment, and this disclosure is not limited thereto.

In summary, the electronic device of this disclosure includes a plurality of pixel areas, which are divided into a plurality of first regions and a plurality of second regions, and includes a first panel, a second panel, a plurality of first filter units, and a plurality of second filter units. The first panel includes a first cholesteric liquid crystal layer for reflecting a first color light. The second panel is disposed at one side of the first panel and includes a second cholesteric liquid crystal layer for reflecting a second color light. The first filter units and the second filter units are disposed between the first cholesteric liquid crystal layer and the second cholesteric liquid crystal layer. The first filter units are respectively located in the first regions, and the second filter units are respectively located in the second regions. The first filter units and the second filter units are configured to absorb lights of different colors. Based on the above structural design, in the electronic device of the present disclosure, the first regions can display images towards the top side, and the second regions can display images towards the bottom side. That is, the user can view the images displayed by the first regions from the top side of the electronic device, but the second regions does not display any image towards the top side of the electronic device. In addition, the user can view the images displayed by the second regions from the bottom side of the electronic device, but the first regions does not display any image towards the bottom side of the electronic device. Accordingly, the electronic device of this disclosure can achieving a double-sided display function, and the top side and the bottom side of the electronic device can display different image contents.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. An electronic device having a plurality of pixel areas, the pixel areas are divided into a plurality of first regions and a plurality of second regions, the electronic device comprising:
a first panel comprising a first cholesteric liquid crystal layer for reflecting a first color light;
a second panel disposed at one side of the first panel and comprising a second cholesteric liquid crystal layer for reflecting a second color light; and
a plurality of first filter units and a plurality of second filter units disposed between the first cholesteric liquid crystal layer and the second cholesteric liquid crystal layer;
wherein, the plurality of first filter units are respectively located in the plurality of first regions, the plurality of second filter units are respectively located in the plurality of second regions, and the plurality of first filter units and the plurality of second filter units are configured to absorb lights of different colors.

2. The electronic device of claim 1, further comprising:
a third panel disposed at one side of the second panel away from the first panel and comprising a third cholesteric liquid crystal layer for reflecting a third color light; and
a plurality of additional second filter units and a plurality of third filter units disposed between the second cholesteric liquid crystal layer and the third cholesteric liquid crystal layer;
wherein, the plurality of additional second filter units are respectively located in the plurality of first regions, the plurality of third filter units are respectively located in the plurality of second regions, and the plurality of additional second filter units, the plurality of third filter units and the plurality of first filter units are configured to absorb lights of different colors.

3. The electronic device of claim 2, further comprising:
a plurality of additional third filter units disposed at one side of the third cholesteric liquid crystal layer away from the second cholesteric liquid crystal layer and respectively located in the plurality of first regions; and
a plurality of light-transmitting units disposed at the side of the third cholesteric liquid crystal layer away from the second cholesteric liquid crystal layer and respectively located in the plurality of second regions.

4. The electronic device of claim 2, further comprising:
a plurality of light-shielding units disposed at one side of the third cholesteric liquid crystal layer away from the second cholesteric liquid crystal layer and respectively located in the plurality of first regions; and
a plurality of light-transmitting units disposed at the side of the third cholesteric liquid crystal layer away from the second cholesteric liquid crystal layer and respectively located in the plurality of second regions.

5. The electronic device of claim 1, further comprising:
a plurality of additional first filter units disposed at one side of the first cholesteric liquid crystal layer away from the second cholesteric liquid crystal layer and respectively located in the plurality of second regions; and
a plurality of light-transmitting units disposed at the side of the first cholesteric liquid crystal layer away from the second cholesteric liquid crystal layer and respectively located in the plurality of first regions.

6. The electronic device of claim 1, further comprising:
a plurality of light-shielding units disposed at one side of the first cholesteric liquid crystal layer away from the second cholesteric liquid crystal layer and respectively located in the plurality of second regions; and
a plurality of light-transmitting units disposed at the side of the first cholesteric liquid crystal layer away from the second cholesteric liquid crystal layer and respectively located in the plurality of first regions.

7. The electronic device of claim 1, further comprising:
a plurality of light-shielding elements disposed between the first cholesteric liquid crystal layer and the second cholesteric liquid crystal layer, wherein one of the plurality of light-shielding elements overlaps, in a top-view direction of the electronic device, a boundary area between one of the plurality of first filter units and adjacent one of the plurality of second filter units.

8. The electronic device of claim 1, wherein the first regions are arranged in multiple rows, the second regions are arranged in multiple rows, and the multiple rows of the first regions and the multiple rows of the second regions are alternately arranged.

9. The electronic device of claim 1, wherein the plurality of first regions and the plurality of second regions are arranged in a stagger manner.

10. The electronic device of claim 1, wherein a wavelength range of the light absorbed by the plurality of first filter units is at least partially overlapped with a wavelength range of the first color light reflected by the first cholesteric liquid crystal layer, and a wavelength range of the light absorbed by the plurality of second filter units is at least partially overlapped with a wavelength range of the second color light reflected by the second cholesteric liquid crystal layer.

11. The electronic device of claim 2, wherein a wavelength range of the light absorbed by the plurality of first filter units is at least partially overlapped with a wavelength range of the first color light reflected by the first cholesteric liquid crystal layer, a wavelength range of the light absorbed by the plurality of second filter units is at least partially overlapped with a wavelength range of the second color light reflected by the second cholesteric liquid crystal layer, and a wavelength range of the light absorbed by the plurality of third filter units is at least partially overlapped with a wavelength range of the third color light reflected by the third cholesteric liquid crystal layer.

12. The electronic device of claim 1, wherein the plurality of first filter units and the plurality of second filter units comprise a solar cell.

13. The electronic device of claim 12, wherein the solar cell comprises a perovskite solar cell (PSC) or a dye-sensitized solar cell (DSC).

14. The electronic device of claim 12, further comprising:
an energy storage unit electrically connected to the plurality of first filter units and the plurality of second filter units, respectively.

15. The electronic device of claim 14, further comprising:
one or more driving circuit units electrically connected to the first panel and the second panel for driving the first panel and the second panel, wherein the one or more driving circuit units are further electrically connected to the energy storage unit.

16. The electronic device of claim 15, wherein each of the one or more driving circuit units comprises a signal conversion circuit.

17. The electronic device of claim 2, wherein the plurality of first filter units, the plurality of second filter units, and the plurality of third filter units comprise a solar cell.

18. The electronic device of claim 17, wherein the solar cell comprises a perovskite solar cell (PSC) or a dye-sensitized solar cell (DSC).

19. The electronic device of claim 17, further comprising:
an energy storage unit electrically connected to the plurality of first filter units and the plurality of second filter units, respectively.

20. The electronic device of claim 17, further comprising:
one or more driving circuit units electrically connected to the first panel, the second panel and the third panel for driving the first panel, the second panel and the third panel, wherein the one or more driving circuit units are further electrically connected to the energy storage unit.
